(19) United States
(12) Patent Application Publication
(10) Pub. No.: US 2023/0159241 A1
(43) Pub. Date: May 25, 2023

(54) Biodegradable Composite Article

(71) Applicant: Celanese International Corporation, Irving, TX (US)

(72) Inventor: Michael Laurin, Pittsfield, MA (US)

(21) Appl. No.: 17/992,276

(22) Filed: Nov. 22, 2022

Related U.S. Application Data
(60) Provisional application No. 63/282,908, filed on Nov. 24, 2021.

(51) Int. Cl. B65D 65/46; B65D 65/40; B65D 81/34; B32B 23/06; B32B 23/20; B32B 7/12; B32B 9/02; B32B 37/12; B32B 9/04

(52) U.S. Cl. CPC B65D 65/466; B65D 65/40; B65D 81/3446; B32B 23/06; B32B 23/20; B32B 7/12; B32B 9/02; B32B 37/12; B32B 9/04; B65D 2565/385; B65D 2581/3437; B32B 2307/7163; B32B 2307/732; B32B 2439/70; B32B 2262/065; B32B 2307/748; B32B 2317/12

(57) ABSTRACT

The present disclosure is directed to laminated articles, such as containers for food and beverages, that are biodegradable and/or paper recyclable. The articles include a shaped fibrous substrate that is air permeable and formed from plant fibers. A film made from a biodegradable and/or paper recyclable polymer is laminated to the substrate to produce a liquid impermeable barrier. The composite article is capable of being frozen and/or heated using, for instance, a microwave oven without delaminating.

### RELATED APPLICATIONS

The present application is based upon and claims priority to U.S. Provisional Patent Application Ser. No. 63/282,908, having a filing date of Nov. 24, 2021, and which is incorporated herein by reference.

### BACKGROUND

Each year, the global production of plastics continues to increase. Over one-half of the amount of plastics produced each year are used to produce plastic bottles, containers, container lids, and other single-use items. The discarded, single-use plastic articles, including all different kinds of packaging, are typically not recycled and end up in landfills. In addition, many of these items are not properly disposed of and end up in streams, lakes, and in the oceans around the world. In fact, plastic waste tends to agglomerate and concentrate in oceans in certain areas of the world due to currents and the buoyancy of the products.

In view of the above, significant development work is ongoing in order to produce single-use containers made from biodegradable materials and/or paper recyclable materials. Various problems have been encountered, however, in being able to produce biodegradable and/or paper recyclable containers that are liquid impermeable and/or safe for use in food handling applications.

One particular area where there is a need to replace fossil fuel-based plastics is in containers that are designed to hold frozen foods and that are capable of being placed and heated in a microwave. In the past, frozen food containers have been made from organic pulp materials. In order to make the containers liquid impermeable and grease resistant, however, the organic pulp material has been combined with a polyfluoroalkyl polymer. The use of fluoropolymers, however, has prevented the materials from being recycled and from being compostable. Consequently, many of these containers are either incinerated or end up in landfills. In addition, recent government regulations have not permitted the use of certain fluoropolymers in food handling applications.

Consequently, a need currently exists for a compostable and/or paper recyclable container that is suitable for food handling applications and is liquid impermeable. A need also exists for a compostable and/or paper recyclable food or beverage container that can not only be used to freeze foods and beverages but can also be used to heat foods and beverages in ovens including microwave ovens.

### SUMMARY

In general, the present disclosure is directed to producing laminated articles, such as containers for food and beverages, that are biodegradable and/or paper recyclable. In one aspect, for instance, the articles are compostable. The articles include a shaped fibrous substrate that is air permeable and formed from plant fibers. In accordance with the present disclosure, a film made from a biodegradable polymer is laminated to the substrate to produce a liquid impermeable barrier that is capable of being frozen and/or heated using, for instance, a microwave oven. The biodegradable film is laminated to the substrate with a bond strength or peel strength that prevents delamination during freezing, thawing, and/or heating.

For example, in one embodiment, the present disclosure is directed to a composite article that includes a fibrous substrate comprising a network of biodegradable fibers. The fibrous substrate defines a surface. A film is laminated to the surface of the fibrous substrate. The film comprises a biodegradable polymer. The biodegradable polymer, for instance, can comprise a polysaccharide ester polymer, such as a cellulose ester polymer. The film can also contain a plasticizer. An adhesive composition is optionally positioned between the surface of the fibrous substrate and the film. The adhesive composition bonds the film to the fibrous substrate. The adhesive composition, similar to the film, can also be biodegradable. Alternatively, the film can contain sufficient plasticizer so that a bond can be formed without the use of an adhesive.

In another embodiment, a composite article is formed from a fibrous substrate comprising a network of biodegradable fibers. A film is laminated to the surface of the fibrous substrate. The film comprises a paper recyclable polymer. The paper recycleable polymer, for instance, can comprise a polysaccharide ester polymer, such as a cellulose ester polymer. The film can also contain a plasticizer. An adhesive composition is optionally positioned between the surface of the fibrous substrate and the film. The adhesive composition bonds the film to the fibrous substrate. The adhesive composition, is water soluble and is compatible with the paper recycling process.

In both embodiments, the fibrous substrate can have a three-dimensional shape and the film can be subjected to heat and pressure sufficient to assume the shape of the fibrous substrate. The fibrous substrate, for instance, can be in the shape of any suitable container, such as a bowl, a beverage container, a food tray, a lid for one of the above articles, or the like. The fibrous substrate, for instance, can be in the shape of a container having an interior surface and an exterior surface. The film can cover at least the interior surface of the fibrous substrate. In one embodiment, the fibrous substate can be encased within the biodegradable film. The biodegradable film, in one embodiment, can have a thickness of from about 10 microns to about 1,000 microns, such as from about 50 microns to about 500 microns, such as from about 80 microns to about 180 microns. The film can comprise an extruded film and/or a cast film. In one aspect, the film can have a matte finish that forms an exterior surface of the article. In addition, various printed matter can be applied to the film, including images, decorations, and the like. The film can be transparent, translucent or opaque. The printed matter can be applied to the surface of the film that forms an exterior surface of the article or can be applied on the opposite surface adjacent the adhesive layer. Because the film can be made transparent, for instance, the printed matter can be visible through the film.

In one aspect, the biodegradable film is formed from a cellulose acetate that can comprise primarily cellulose diacetate. The cellulose ester polymer can be present in the film in an amount from about 55% to about 95% by weight. One or more plasticizers can be contained in the film in an amount from about 5% by weight to about 45% by weight. In one aspect, the cellulose acetate has a degree of substitution of from about 2.1 to about 2.8.

Any suitable plasticizer that is biodegradable and preferably approved for food contact can be used. In one aspect, the plasticizer can comprise a triglyceride. Alternatively, the plasticizer can comprise tris(clorisopropyl) phosphate, tris(2-chloro-1-methylethyl) phosphate, glycerin, triethyl citrate, acetyl triethyl citrate, an adipate, polyethylene glycol, trimethyl phosphate, triethyl phosphate, tributyl phosphate, triphenyl phosphate, tributyl-o-acetyl citrate, dibutyl tartrate, ethyl o-benzoylbenzoate, n-ethyltoluenesulfonamide, o-cresyl p-toluenesulfonate, an aromatic diol, a substituted aromatic diol, an aromatic ether, tripropionin, tribenzoin, a glycerin ester, glycerol tribenzoate, glycerol acetate benzoate, polyethylene glycol, a polyethylene glycol ester, a polyethylene glycol diester, di-2-ethylhexyl polyethylene glycol ester, a glycerol ester, diethylene glycol, polypropylene glycol, a polyglycoldiglycidyl ether, dimethyl sulfoxide, N-methyl pyrollidinone, propylene carbonate, a C1-C20 dicarboxylic acid ester, di-butyl maleate, di-octyl maleate, resorcinol monoacetate, catechol, catechol esters, phenols, epoxidized soy bean oil, castor oil, linseed oil, epoxidized linseed oil, difunctional glycidyl ether based on polyethylene glycol, an alkyl lactone, a phospholipid, 2-phenoxyethanol, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, a monoacetyglycol, a diacetylglycol, a piperidine, a piperazine, hexamethylene diamine, triazine, triazole, a pyrrole, and mixtures thereof.

The fibrous substrate, as described above, can be made from plant fibers. In one aspect, the fibers can comprise a pulp that has been delignified and/or refined. The plant fibers, for instance, can comprise pulp fibers, such as softwood fibers. Alternatively, the plant fibers can comprise bast fibers. Fibers that can be used to construct the fibrous substrate include bamboo fibers, cornhusk fibers, sugarcane fibers, flax fibers, baggasse fibers, jute fibers, or mixtures thereof.

Once laminated to the fibrous substrate, the film can have a relatively strong peel strength. For instance, the film can have an average bond strength of greater than about 0.75 N, such as greater than about 1.15 N, such as greater than about 1.5 N, and generally less than about 4 N when measured according to a 90° peel test at a speed of 12 inches per minute.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figure, in which:

FIG. 1 is a side view of one embodiment of a container made in accordance with the present disclosure;

FIG. 2 is a cross-sectional view of the container illustrated in FIG. 1;

FIG. 3 is a cross-sectional view of one embodiment of an adhesive coated film that may be used in accordance with the present disclosure;

FIG. 4 is a side view illustrating one embodiment of a process for laminating a container in accordance with the present disclosure; and

FIG. 5 is a cross-sectional view of an alternative embodiment of a process for laminating a container in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to composite molded articles, such as containers, that are made from biodegradable and/or paper recyclable materials. In one embodiment, for instance, the composite article of the present disclosure is home or industrially compostable. In a second embodiment, for instance, the composite article of the present disclosure is paper recyclable. In one aspect, for instance, articles made according to the present disclosure include a biodegradable/paper recyclable polymer film that is laminated and molded to at least one surface of an air permeable, fibrous substrate. The fibrous substrate, for instance, can be made from plant fibers. The biodegradable/paper recyclable film, on the other hand, can be made from a polysaccharide ester polymer, such as a cellulose ester polymer.

Articles made according to the present disclosure have numerous and diverse uses and applications. Of particular advantage, the composite articles can be made so as to be completely safe for contact with food and beverages. One particular problem faced in the past was designing a biodegradable and/or compostable/paper recyclable food container that could be used to store frozen food and also be used to heat the food, such as in a microwave oven. In the past, these types of containers were typically made from petroleum-based plastics that were discarded after a single use and not recycled. As an alternative to plastic containers, those skilled in the art have also suggested making the food containers from pulp fibers. In the past, however, these containers were treated with a polyfluoroalkyl polymer which not only prevented the container from entering the paper recycle stream or being compostable, but also included a fluoropolymer that has been recently subjected to higher governmental scrutiny. The present disclosure solves the above problem and provides a food container that can not only be used to hold food when frozen but also can be rapidly thawed in a microwave or oven while still being made from biodegradable/paper recyclable materials. Containers made according to the present disclosure, for instance, can be placed in the recycle stream and can be compostable. Further, the containers of the present disclosure can be frozen with a food product and rapidly heated without delaminating, disfiguring, or degrading.

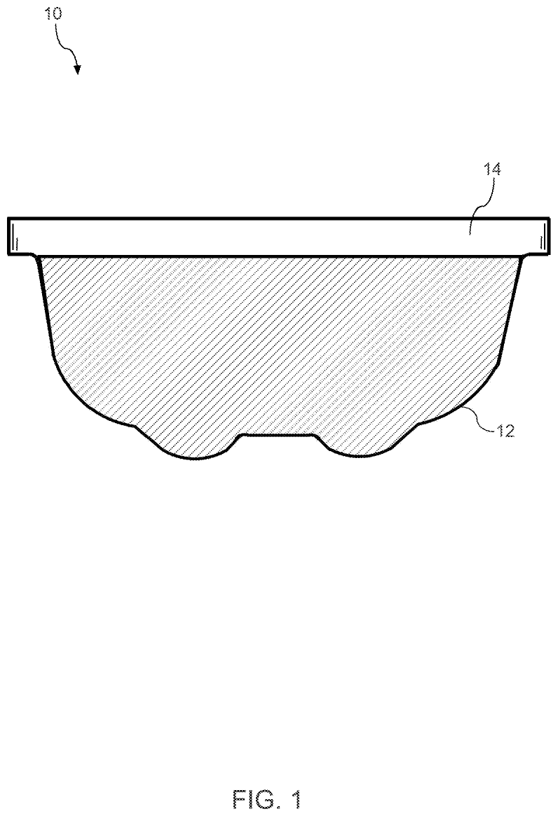

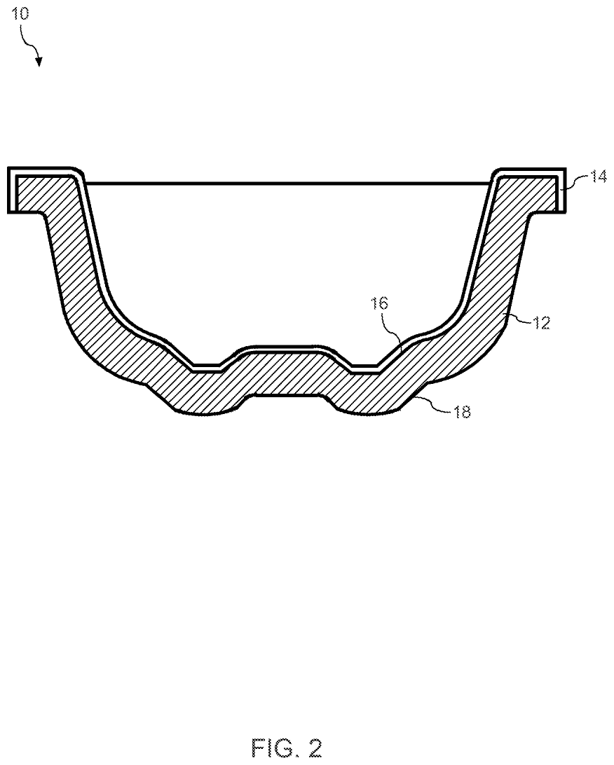

Referring to FIGS. 1 and 2, for instance, one embodiment of a container 10 made in accordance with the present disclosure is shown. As illustrated in FIGS. 1 and 2, the container 10 includes a fibrous substrate 12 that has been laminated to a film layer 14. In the embodiment illustrated in FIGS. 1 and 2, the film layer 14 has been laminated to the interior surface 16 of the fibrous substrate 12. Consequently, the fibrous substrate 12 forms the exterior surface 18 of the container 10. In other embodiments, however, the fibrous substrate 12 can be completely enclosed within the film layer 14. For instance, the film layer 14 can extend over the interior surface 16 and over the exterior surface 18. The film layer 14 made in accordance with the present disclosure forms a liquid impermeable surface of the container 10. In addition, the container 10 can be filled with a food product and frozen, cooled, and/or heated without the film layer 14 delaminating from the fibrous substrate 12. In addition, the film layer 14 can be formulated so as to be completely biodegradable and compostable/paper recyclable.

The fibrous substrate 12 can be made from any suitable fibrous material, particularly organic fibers such as plant fibers. In one embodiment, the fibrous substrate 12 is formed from pulp fibers. Pulp fibers refer to delignified fibers that have undergone a pulping process, such as in a digester. The pulp fibers, for instance, can comprise wood pulp fibers. Wood pulp fibers include softwood fibers, hardwood fibers, or combinations thereof.

Other fibers that may be present within the fibrous substrate 12 include cotton fibers, linen fibers, regenerated cellulose fibers, such as rayon fibers or viscose fibers, recycled textile fibers, and the like. In one embodiment, the fibrous substrate 12 can contain bast fibers either alone or in combination with wood pulp fibers. Bast fibers that can be present in the fibrous substrate 12 include flax fibers, sugarcane fibers, bamboo fibers, hemp fibers, abaca fibers, kozo fibers, fibers from ground nutshells, mixtures thereof, and the like. In still another aspect, the fibrous substrate 12 can contain corn husk fibers.

When formed partially or exclusively from pulp fibers, particularly wood pulp fibers, the fibrous substrate 12 can have integrity through hydrogen bonding. In one aspect, a binder can be added during formation of the fibrous substrate in order to increase integrity. Binders that can be incorporated into the fibrous substrate 12 include all different types of natural gums. Natural gums that can be used include guar gums, gum arabic, alginate gums, and the like. Other binders that can be used include starch, polyvinyl alcohol, polyglycolic acid, and mixtures thereof.

In one aspect, the binder can be a biodegradable polymer, such as a biodegradable aliphatic polyester. Biodegradable polyesters include, for instance, polylactic acid, poly-E-caprolactone, polyhydroxybutyrate, poly(3-hydroxyvalerate), polybutylene adipate succinate, and mixtures thereof.

When present, one or more binders can be contained in the fibrous substrate 12 in an amount less than about 5% by weight, such as in an amount less than about 3.5% by weight, such as in an amount less than about 3% by weight, such as in an amount less than about 2.5% by weight, and generally in an amount greater than about 0.1% by weight, such as in an amount greater than about 0.5% by weight, such as in an amount greater than about 1% by weight.

The fibrous substrate 12 can be made using various different processes. In one aspect, the fibrous substrate 12 can be compression molded. The fibrous substrate 12, for instance, can be compression molded using a wet or aqueous slurry of the fibrous materials or can be formed in an airlaid process. When formed in an airlaid process, a fluff pulp material can be placed in a mold and compacted.

The fibrous substrate 12 can have a thickness and a basis weight that can vary depending upon the particular application and the desired result. For example, the fibrous substrate 12 can be relatively compact in one embodiment or can comprise a higher bulk material in an alternative embodiment. As will be described in greater detail below, the fibrous substrate 12 can have any suitable thickness or basis weight as long as the fibrous substrate 12 maintains a level of air permeability that permits lamination to the film layer 14. In one aspect, the fibrous substrate has a basis weight of from about 12 gsm to about 80 gsm, such as from about 14 gsm to about 25 gsm. The thickness of the fibrous substrate can be greater than about 0.3 mm, such as greater than about 0.5 mm and less than about 10 mm, such as less than about 5 mm, such as less than about 1 mm, such as less than about 0.7 mm.

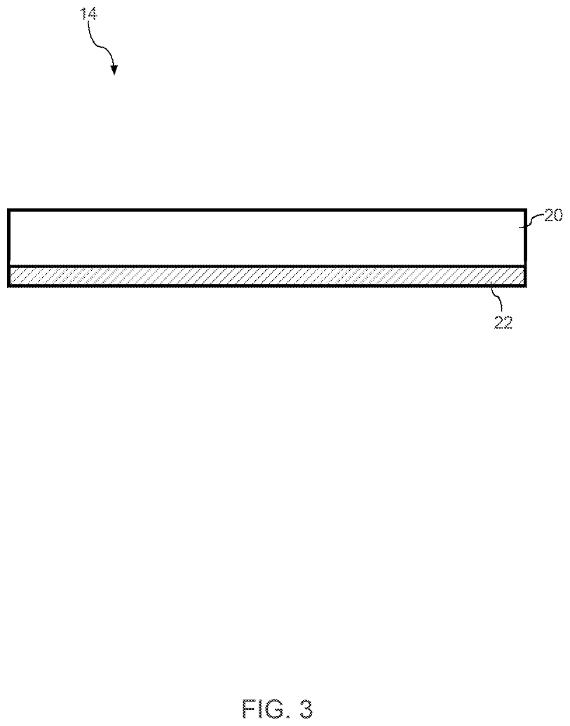

The film layer 14 laminated to the fibrous substrate 12 can be made from a biodegradable/paper recyclable polymer in accordance with the present disclosure. One embodiment of the film layer 14 is shown in FIG. 3. The film layer 14 includes a film 20 made from one or more biodegradable/paper recyclable polymers. On one side of the film is an optional adhesive layer 22. The adhesive layer 22 can also be made from a biodegradable and/or paper recyclable material. The adhesive layer 22 is positioned between the film 20 and the fibrous substrate 12 and is used to bond the film 20 to a surface of the fibrous substrate. Alternatively, the film 20 can be formulated so as to form a thermal bond with the fibrous substrate without the use of an adhesive.

In one embodiment, the film 20 is made from a polymer composition containing a polysaccharide ester polymer, such as a cellulose ester polymer.

In one aspect, the polymer composition contains a cellulose ester polymer combined with at least one plasticizer. The polymer composition can optionally contain various other additives and ingredients. The polymer composition can be particularly formulated to produce films having excellent optical properties. Of particular advantage, the optical properties of the films can be retained in the three-dimensional articles produced according to the present disclosure.

In general, any suitable cellulose ester polymer can be incorporated into the polymer composition. In one aspect, the cellulose ester polymer is a cellulose acetate. Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses of the Miscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in producing the composition of the present disclosure may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof.

The cellulose acetate used in the composition may be cellulose diacetate or cellulose triacetate. In one embodiment, the cellulose acetate comprises primarily cellulose diacetate. For example, the cellulose acetate can contain less than 1% by weight cellulose triacetate, such as less than about 0.5% by weight cellulose triacetate. Cellulose diacetate can make up greater than 90% by weight of the cellulose acetate, such as greater than about 95% by weight, such as greater than about 98% by weight, such as greater than about 99% by weight of the cellulose acetate.

In general, the cellulose acetate can have a molecular weight of greater than about 10,000, such as greater than about 20,000, such as greater than about 30,000, such as greater than about 40,000, such as greater than about 50,000. The molecular weight of the cellulose acetate is generally less than about 300,000, such as less than about 250,000, such as less than about 200,000, such as less than about 150,000, such as less than about 100,000, such as less than about 90,000, such as less than about 70,000, such as less than about 50,000. The molecular weights identified above refer to the number average molecular weight. Molecular weight can be determined using gel permeation chromatography using a polystyrene equivalent or standard.

The biodegradation of the cellulose ester polymer can depend upon various factors including the degree of substitution. The degree of substitution of the cellulose ester can be measured, for example, using ASTM Test 871-96 (2010). The cellulose acetate polymer incorporated into the polymer composition can generally have a degree of substitution of greater than about 2.0, such as greater than about 2.1, such as greater than about 2.2, such as greater than about 2.3. The degree of substitution is generally less than about 3.3, such as less than about 3.0, such as less than about 2.8, such as less than about 2.6. In one aspect, for instance, the cellulose acetate polymer has a degree of substitution of from about 2.1 to about 2.8, including all increments of 0.1 therebetween.

The cellulose ester polymer or cellulose acetate can have an intrinsic viscosity of generally greater than about 0.5 dL/g, such as greater than about 0.8 dL/g, such as greater than about 1 dL/g, such as greater than about 1.2 dL/g, such as greater than about 1.4 dL/g, such as greater than about 1.6 dL/g. The intrinsic viscosity is generally less than about 2 dL/g, such as less than about 1.8 dL/g, such as less than about 1.7 dL/g, such as less than about 1.65 dL/g. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$IV = ( \frac{k}{c} ) ( antilog ( ( log {n}_{ret} ) / k ) - 1 ) where {n}_{ret} = ( \frac{{t}_{1}}{{t}_{2}} ) , \qquad Equation 1$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

The cellulose acetate is generally present in the polymer composition used to produce the film in an amount greater than about 20% by weight, such as in an amount greater than about 25% by weight, such as in an amount greater than about 30% by weight, such as in an amount greater than about 35% by weight, such as in an amount greater than about 40% by weight, such as in an amount greater than about 45% by weight, such as in an amount greater than about 50% by weight, such as in an amount greater than about 55% by weight, such as in an amount greater than about 62% by weight, such as in an amount greater than about 65% by weight. The cellulose acetate is generally present in the polymer composition in an amount less than about 85% by weight, such as in an amount less than about 82% by weight, such as in an amount less than about 80% by weight, such as in an amount less than about 74% by weight, such as in an amount less than about 71% by weight.

The cellulose ester polymer can be combined with one or more plasticizers. Plasticizers particularly well suited for use in the polymer composition include polyalkylene glycols and/or polyglycerides. For example, the plasticizer can comprise a monoglyceride, a diglyceride, a triglyceride, or polyethylene glycol. In one particular aspect, the plasticizer comprises 1,2,3-triacetylglycol. In other aspects, however, the plasticizer can be a diacetylglycol or a monoacetylglycol alone or in combination with a triacetylglycol. Other suitable plasticizers include tris(clorisopropyl) phosphate, tris(2-chloro-1-methylethyl) phosphate, triethyl citrate, acetyl triethyl citrate, glycerin, or mixtures thereof.

Other examples of plasticizers include, but are not limited to, trimethyl phosphate, triethyl phosphate, tributyl phosphate, triphenyl phosphate, acetyl tributyl citrate, tributyl-o-acetyl citrate, dibutyl tartrate, ethyl o-benzoylbenzoate, n-ethyltoluenesulfonamide, o-cresyl p-toluenesulfonate, aromatic diol, substituted aromatic diols, aromatic ethers, tripropionin, tribenzoin, glycerin, glycerin esters, glycerol tribenzoate, glycerol acetate benzoate, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., .gamma.-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

In one aspect, a carbonate ester may serve as a plasticizer. Exemplary carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

In still another aspect, the plasticizer can be a polyol benzoate. Exemplary polyol benzoates may include, but are not limited to, glyceryl tribenzoate, propylene glycol dibenzoate, diethylene glycol dibenzoate, dipropylene glycol dibenzoate, triethylene glycol dibenzoate, sucrose benzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

In one aspect, the plasticizer can be a sulfonamide plasticizer. For instance, the plasticizer can be a toluene sulfonamide plasticizer. The toluene sulfonamide plasticizer can have a melting point of less than about 120° C., such as less than about 115° C. The sulfonamide plasticizer can be combined with any of the other plasticizers described above.

In one aspect, the plasticizer is phthalate-free. In fact, the polymer composition can be formulated to be phthalate-free. For instance, phthalates can be present in the polymer composition in an amount of about 0.1% or less, such as in an amount of about 0.001% or less.

In general, one or more plasticizers can be present in the polymer composition in an amount from about 5% to about 48% by weight, such as from about 15% to about 48% by weight, such as in an amount from about 18% to about 36% by weight. In one aspect, one or more plasticizers can be present in the polymer composition in an amount of greater than about 20% by weight, such as in an amount greater than about 23% by weight, such as in an amount greater than about 25% by weight, such as in an amount greater than about 27% by weight, such as in an amount greater than about 29% by weight, and generally in an amount less than about 43% by weight, such as in an amount less than about 36% by weight.

Antioxidants may, in some embodiments, mitigate oxidation and/or chemical degradation of a cellulose ester plastic described herein during storage, transportation, and/or implementation. Antioxidants suitable for use in conjunction with a cellulose ester plastic described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In one aspect, the antioxidant incorporated into the polymer composition is a phosphite. For example, the antioxidant can be a polyphosphite, such as a diphosphite. In one particular embodiment, for instance, the antioxidant incorporated into the polymer composition is Bis(2,4-dicumylphenyl) pentaerythritol diphosphite.

In some embodiments, antioxidants suitable for use in conjunction with a cellulose ester plastic described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, phosphites, and the like, and any combination thereof.

Any of the above antioxidants, including the phosphites described above, can be incorporated into the polymer composition generally in an amount greater than about 0.001% by weight, such as in an amount greater than about 0.01% by weight, such as in an amount greater than about 0.05% by weight, such as in an amount greater than about 0.08% by weight, and generally in an amount less than about 0.35% by weight, such as in an amount less than about 0.3% by weight, such as in an amount less than about 0.25% by weight, such as in an amount less than about 0.2% by weight, such as in an amount less than about 0.15% by weight, such as in an amount less than about 0.1% by weight. In one embodiment, the polymer composition contains a phosphite antioxidant alone or in combination with one of the other antioxidants described above.

The polymer composition of the present disclosure can also include a polycarboxylic acid. The polycarboxylic acid, for instance, can be a dicarboxylic acid or a tricarboxylic acid. In one aspect, the polycarboxylic acid can be citric acid. The polycarboxylic acid, such as the citric acid, can be present in the polymer composition in an amount greater than about 0.001% by weight, such as in an amount greater than about 0.005% by weight, such as in an amount greater than about 0.01% by weight, such as in an amount greater than about 0.03% by weight. One or more polycarboxylic acids can be present in the polymer composition generally in an amount less than about 0.1% by weight, such as in an amount less than about 0.08% by weight, such as in amount less than about 0.06% by weight, such as in an amount less than about 0.04% by weight.

In addition to a cellulose ester polymer, one or more plasticizers, one or more antioxidants, and one or more polycarboxylic acids, the polymer composition can also contain various other additives and ingredients. For example, the polymer composition can also contain an odor masking agent. The odor masking agent, for instance, can absorb odors and/or produce its own odor. Masking agents that may be incorporated into the composition include zeolites, particularly synthetic zeolites, fragrances, and the like.

Other additives and ingredients that may be included in the polymer composition include pigments, lubricants, softening agents, antibacterial agents, antifungal agents, preservatives, flame retardants, and combinations thereof. Each of the above additives can generally be present in the polymer composition in an amount of about 5% or less, such as in an amount of about 2% or less, and generally in an amount of about 0.1% or greater, such as in an amount of about 0.3% or greater.

Flame retardants suitable for use in conjunction with a cellulose ester plastic described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with a cellulose ester plastic described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with a cellulose ester plastic described herein may, in some embodiments, include, but are not limited to, benzoates, parabens (e.g., the propyl-4-hydroxybenzoate series), and the like, and any combination thereof.

Pigments and dyes suitable for use in conjunction with a cellulose ester plastic described herein may, in some embodiments, include, but are not limited to, solvent-based dyes, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with a cellulose ester plastic described herein may be food-grade pigments and dyes. Examples of food-grade pigments and dyes may, in some embodiments, include, but are not limited to, plant dyes, vegetable dyes, titanium dioxide, and the like, and any combination thereof.

It should be understood that many of the above additives and ingredients are optional. For instance, in particular embodiments, there may be advantages to excluding certain materials from the polymer composition. For example, in one aspect, the polymer composition is formulated without containing any filler particles, particularly white filler particles.

The polymer composition can also be formulated without containing any tackifying resins. In still another aspect, the polymer composition can be free from any thermoplastic polymers except for the cellulose ester polymer. In one aspect, in addition to the cellulose ester polymer, the polymer composition contains other thermoplastic polymers in an amount less than about 15% by weight, such as in an amount less than about 10% by weight, such as in an amount less than about 3% by weight. In one embodiment, for instance, the cellulose ester polymer can be combined with other biodegradable polymers, such as polylactic acid, polycaprolactone, polyhydroxybutyrate, or mixtures thereof. In one particular aspect, the polymer composition only contains the cellulose ester polymer, one or more plasticizers, one or more antioxidants, and one or more polycarboxylic acids.

Films can be made from the above described polymer composition using various methods and techniques. For instance, the film can be formed through a casting process, can be extruded or can be a blown film. In one embodiment, for instance, in order to form a film, the cellulose ester polymer in powder or flake form and optionally a plasticizer and other ingredients are combined with a solvent and formed into a dope. The dope can then be used in a solvent casting process to form the film.

In an alternative embodiment, the polymer composition is heated to a temperature and melt-extruded to form the film. For example, the composition can be heated to a viscosity of from about 50,000 cp to about 200,000 cp, such as from about 80,000 cp to about 120,000 cp.

Any suitable extruder can be used in order to produce the film. For example, the extruder can be a co-rotating twin screw extruder or alternatively can be a single screw extruder. During extrusion, the polymer composition can generally be heated to a temperature of from about 170° C. to about 235° C., such as from about 190° C. to about 220° C. In one aspect, the hot molten polymer is fed onto a polished metal band or drum with an extrusion die. Once on the band or drum, the film can be cooled and peeled from the metal support.

The formed film can have a thickness of from about 10 microns to about 1000 microns, such as from about 12 microns to about 200 microns, such as from about 20 microns to about 180 microns. The film, for example, can have a thickness of greater than about 10 microns, such as greater than about 12 microns, such as greater than about 15 microns, such as greater than about 20 microns, such as greater than about 25 microns, such as greater than about 30 microns, such as greater than about 35 microns, such as greater than about 40 microns. The thickness of the film is generally less than about 200 microns, such as less than about 150 microns, such as less than about 100 microns, such as less than about 50 microns.

If desired, the film may be uniaxially stretched or biaxially stretched using any suitable method. For instance, the film can be stretched using a roll method or using a tenter frame. Stretching the film can thin the film and possibly improve optical properties. The draw ratio in the machine direction or the cross-machine direction can generally be from about 1.5 to about 4, such as from about 2 to about 3.

Films made in accordance with the present disclosure can have excellent optical properties. These optical properties can be retained after the film has been molded with the fibrous substrate. For example, films made according to the present disclosure can have relatively low haze when measured according to ASTM Test D1003 (2013).

Haze can be measured using any acceptable instrument according to the ASTM Test including, for instance, a BYK Gardner Haze-Gard 4725 instrument. Haze can be measured on a test plaque, on a film made according to the present disclosure, or on the final article. The test plaque can have any suitable thickness, such as 1 mm, 2 mm, 3 mm, or 4 mm. When any of the above samples are tested, the haze of the sample or article can generally be less than about 10%, such as less than about 8%, such as less than about 5%, such as less than about 3%, such as less than about 2%. In one aspect, the haze can be less than 1%, such as less than about 0.8%, such as less than about 0.5%, such as less than about 0.4%, such as less than about 0.3%, such as less than about 0.2%.

In addition to low haze, polymer films and articles made according to the present disclosure can also have high transmission rates, whether the article is translucent (e.g. is a shade of color containing one or more coloring agents) or transparent. For example, when measured for transmission properties at a wavelength of from about 380 nm to about 780 nm, the polymer film or article can display a transmission of greater than about 70%, such as greater than about 75%, such as greater than about 80%, such as greater than about 85%, such as greater than about 90%, such as greater than about 95%.

The thickness of the biodegradable/paper recyclable film used in accordance with the present disclosure is generally less than about 200 microns. For instance, the thickness can be less than about 180 microns, such as less than about 160 microns, such as less than about 140 microns, such as less than about 120 microns, such as less than about 60 microns. The thickness is generally greater than about 5 microns, such as greater than about 10 microns, such as greater than about 40 microns. In one aspect, the thickness of the film can be from about 45 microns to about 55 microns.

As shown in FIG. 3, the biodegradable/paper recyclable film 20 can optionally be coated with an adhesive layer 22. The adhesive layer 22 can be made from any suitable adhesive composition. In one aspect, the adhesive composition used to produce the adhesive layer 22 is biodegradable.

In one aspect, the adhesive composition used to produce the adhesive layer 22 is paper recyclable.

In one aspect, the adhesive layer 22 is made from a heat activated and/or a pressure sensitive adhesive with low tack properties. For example, the adhesive composition can comprise an acrylic polymer. The adhesive composition, for instance, can be an emulsion acrylic composition or a solvent acrylic composition.

In one embodiment, the adhesive composition can comprise a biodegradable gelatin. For example, the adhesive composition can comprise a water-based gelatin. Gelatin compositions, for instance, are completely biodegradable.

The adhesive composition can be coated on one side of the film 20 in order to produce the adhesive layer 22 using any suitable process or technique. For instance, the adhesive composition can be coated onto the film 20 using knife coating methods, slot-die coating, bar coating, or the like. In one application, the adhesive composition can be applied to one surface of the film 20 while the film 20 is at an elevated temperature and during formation of the film. In this manner, the heat of the film can be used to dry the coating on the film.

The thickness of the adhesive layer 22 is generally less than the thickness of the film 20. For instance, the adhesive layer 22 can have a thickness of less than about 30 microns, such as less than about 20 microns, such as less than about 10 microns, such as less than about 8 microns, such as less than about 5 microns, such as less than about 4 microns, such as less than about 3 microns, such as less than about 2 microns, and generally greater than about 0.1 microns, such as greater than about 0.5 microns, such as greater than about 1 micron.

In one embodiment, the film layer 14 can first be produced and wound into a roll. The roll can then be unwound and fed into a process for laminating the film layer 14 to the fibrous substrate 12.

The adhesive layer 22 can be applied to either surface of the film 20. When forming a cast film, the film 20 can, in one embodiment, include a side with a matte finish and a polished side having higher gloss characteristics. In one embodiment, the adhesive composition is applied to the polished side of the film 20.

As described above, the fibrous substrate 12 is formed in a manner such that the substrate is air permeable and porous. In one aspect, the porous nature of the fibrous substrate 12 can be used to assist in laminating the film layer 14 to a surface of the fibrous substrate 12. For instance, pressure can be applied to the film layer 14 and/or a suction force or vacuum can be applied to the opposite side of the fibrous substrate 12 during the lamination process. In this manner, airflow through the porous substrate 12 maintains pressure between the film layer 14 and a surface of the fibrous substrate 12 for ensuring that an adequate bond is produced between the two layers. Various different laminating processes can be used to produce the container 10. For instance, the container 10 can be produced through vacuum thermoforming, drape forming, high pressure forming, plug assist forming, hydroforming, or match die forming. In general, the film layer 14 is heated and pressure is applied between the fibrous substrate 12 and the film layer 14 for a time of from about 1 to about 60 seconds for forming a bond between the two layers. During the process, the fibrous substrate 12 can be placed inside a cavity of a mold of similar geometry in order to provide support to the fibrous substrate walls during forming the product.

As described above, the film layer 14 can be formed with excellent optical properties. The film layer 14, for instance, can be highly transparent or translucent and can have very low haze properties. Thus, in one embodiment, printed matter including various designs can be applied to the fibrous substrate 12 and/or the film layer 14 and can be visible through the film layer 14 after the two articles have been laminated together. The printed matter can include instructions such as how to store and/or heat a food product contained within the container. Alternatively, the printed matter can include decorative designs and images, patterns, trademarks, logos, and the like.

Printed matter can be applied to the fibrous substrate 12 or to the film layer 14 using any suitable method. For instance, one or both of the articles can be subjected to screen printing, laser marking, pad printing, digital printing, dye sublimation, transfer printing, offset printing, digital offset printing, or gravure printing. In one aspect, laser marking is used instead of printing.

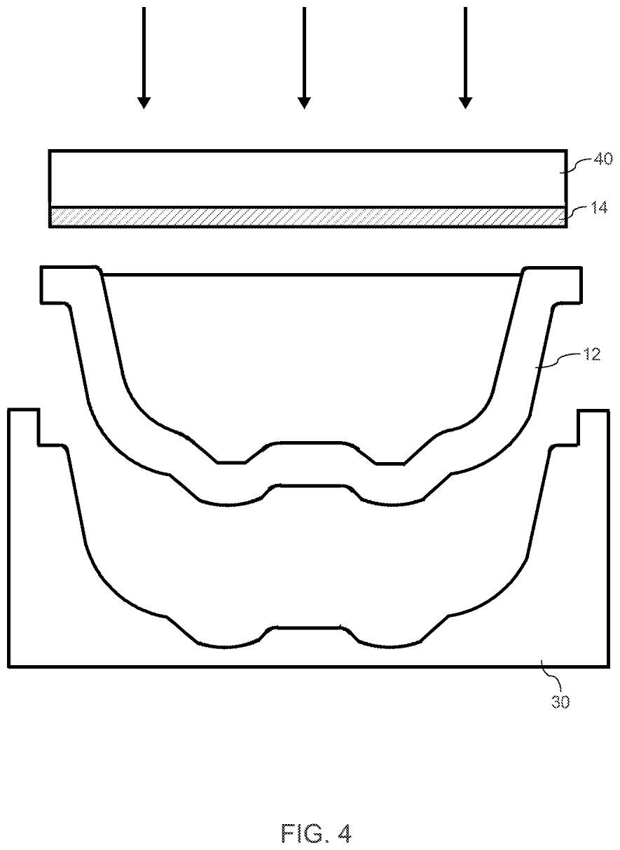

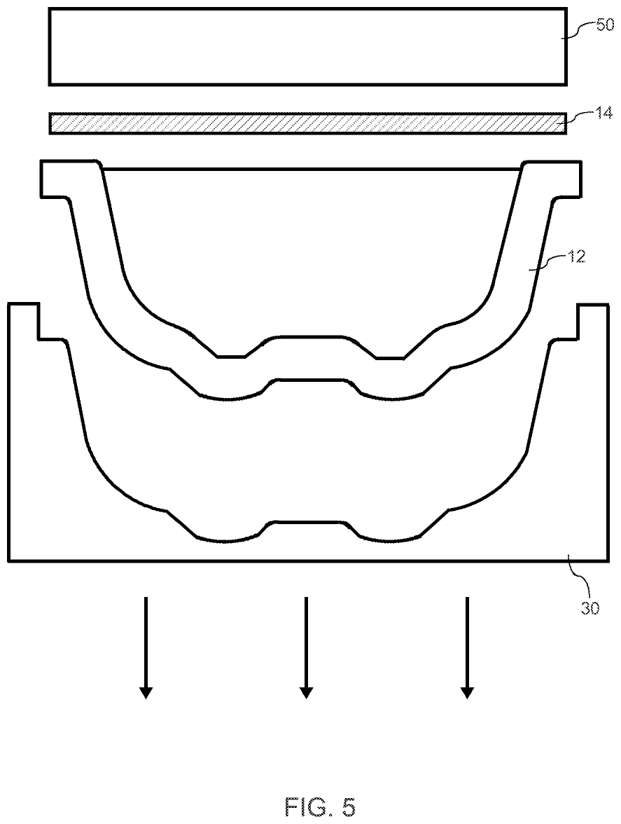

Referring to FIGS. 4 and 5, two different methods for laminating the film layer 14 to the fibrous substrate 12 are illustrated. FIG. 4, for instance, illustrates one embodiment of a pressure forming process. As shown in FIG. 4, the fibrous substate 12 is placed into a mold 30 that defines a cavity that is complementary with the shape of the fibrous substrate 12. The mold 30, for instance, can be made from any suitable material, such as aluminum. The mold 30 can also include passageways for allowing gases to pass through the mold.

In order to laminate the film layer 14 to the fibrous substrate 12, the film layer 14 is first heated by being placed adjacent to a heated platen 40. In one embodiment, air pressure can be used to hold the film layer 14 in direct contact with the heated platen 40. Although direct contact may not be necessary, contact between the film layer 14 and the heated platen 40 provides for extremely fast heat transfer to the film layer 14. The film layer 14, for instance, can be heated to a temperature greater than about 300° F., such as greater than about 350° F., such as greater than about 380° F., such as greater than about 400° F., such as greater than about 410° F,such as greater than about 420° F,and generally less than about 500° F., such as less than about 460° F.

The heated platen 40 can be placed in communication with a pneumatic gas source, such as a pneumatic air source for then applying pressure to the heated film layer 14. For example, pneumatic pressure can be applied from the heated platen 40 to the film layer 14 in an amount greater than about 300 psi, such as greater than about 350 psi, such as greater than about 400 psi, such as greater than about 425 psi, such as greater than about 435 psi, such as greater than about 445 psi, and generally less than about 550 psi, such as less than about 500 psi. The pneumatic pressure forces the film layer 14 against the interior surface of the fibrous substrate 12 and causes the heated film to not only bond to the fibrous substrate 12 but also assume the shape of the fibrous substrate 12. Of particular advantage, the porosity of the fibrous substrate 12 allows for the gas, such as air, to evacuate directly through the fibrous substrate.

Through the above process, an excellent bond forms between the film layer 14 and the fibrous substrate 12. In addition, the process is very efficient having cycle times of less than about 15 seconds, such as less than about 10 seconds. In one embodiment, about 100 to about 140 psi of pressure is applied to the film layer 14 in order to place the film layer in contact with the heated platen 40. The contact time between the film layer 14 and the heated platen 40 can be from about 2 seconds to about 3 seconds. The film layer 14 can then be applied to the fibrous substrate 12 in a time of from about 0.5 seconds to about 2 seconds. Finally, from about 1 second to about 4 seconds of evacuation time is needed in order to allow the pneumatic pressure to evacuate through the porous fibrous substrate 12.

Referring to FIG. 5, another embodiment of a process for laminating the film layer 14 to the fibrous substrate 12 is illustrated. The embodiment illustrated in FIG. 5 is a vacuum assisted thermoforming method.

As shown in FIG. 5, the film layer 14 is heated using a heated platen 50. The film layer 14 can be placed in direct contact with the heated platen 50 or can be spaced from the heated platen 50 in order to heat the film layer 14. In one embodiment, for instance, the film layer 14 can be placed within about 6 inches from the surface of the heated platen 50. The film layer 14 is then heated to a temperature of greater than about 300° F., such as greater than about 320° F., such as greater than about 340° F., and generally less than about 400° F., such as less than about 350° F. The platen 50, on the other hand, can be at a temperature of from about 400° F. to about 600° F.

After the film layer 14 is heated, a suction force is applied to the mold 30 and to the fibrous substrate 12. Because the mold 30 and the fibrous substrate 12 are air permeable, the suction force is applied to the heated film layer 14. For instance, the suction force or vacuum can be applied at a pressure of greater than about 0.8 ATM, such as greater than about 1 ATM, such as greater than about 1.2 ATM, and generally less than about 2 ATM, such as less than about 1.5 ATM. The vacuum or suction force is applied for a time sufficient for the film layer 14 to assume the shape of the fibrous substrate 12 and to bond to the fibrous substrate 12. Pressure can be applied, for instance, for generally less than about 3 minutes, such as less than about 2 minutes, such as less than about 1 minute, such as less than about 30 seconds.

Through the process of the present disclosure, a very durable and strong bond is formed between the film layer 14 and a surface of the fibrous substrate 12. For example, when tested according to a peel test, such as ASTM Test D6862-11 (2021), the film layer can have an average bond strength of greater than about 0.75 N, such as greater than about 1.15 N, such as greater than about 1.5 N, such as greater than about 1.75 N, and generally less than about 4 N when tested at a speed of 12 inches per minute. The bond can be formed using an adhesive as a tie layer. Alternatively, the cellulose ester film can bond directly to the fibrous substrate.

In addition to having a significant bond strength, the bond that forms between the film layer 14 and the surface of the fibrous substrate 12 is also very durable. For instance, the film layer 14 will not delaminate from the fibrous substrate 12 even when subjected to freeze and rapid thaw/cook cycles. For example, the container 10 of the present disclosure can withstand a test in which the container is filled 85% full of water which is frozen in the container for a minimum of four hours. The water is then thawed in a microwave oven on high and brought to a boil for two minutes. Even during this test, no delamination occurs.

Containers made in accordance with the present disclosure can be used in all different types of applications. As described above, the container is particularly well suited for holding a frozen food item and then thawing the food item within the container. In this regard, the materials used to produce the container can meet all of the requirements of 21 CFR 175.105 and of 21 CFR 175.125 meaning that the container is food contact compliant.

The present disclosure may be better understood with reference to the following example.

### EXAMPLE

The process illustrated in FIG. 4 was used to produce containers in accordance with the present disclosure. The fibrous substrate used to produce the container was made from sugarcane pulp fibers having a basis weight of about 16 gsm. A 50 micron cellulose ester polymer film was laminated to the fibrous substrate to form a bowl. The film contained about 19% triacetin. The cellulose ester polymer film was a cast film. An acrylic based heat activatable adhesive or a bio-based adhesive (biodegradable gelatin) was coated on the polished side of the film. The adhesive layer had a thickness of from about 2.5 microns to about 3 microns.

The containers were subjected to two tests. In Test 1, water was frozen overnight in the container. The water was then brought to boil for 1 minute and the bowl was tested for delamination. In Test 2, boiling water was poured into the bowl and delamination was tested after the water reached a temperature of 80° C. Samples containing each adhesive performed favorably according to both tests.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A composite article comprising:
a fibrous substrate comprising a network of biodegradable and/or paper recyclable fibers, the fibrous substrate defining a surface;
a film laminated to the surface of the fibrous substrate, the film comprising a biodegradable and/or paper recyclable polymer, the biodegradable and/or paper recyclable polymer comprising a cellulose ester polymer, the film further comprising a plasticizer; and
optionally an adhesive composition positioned between the surface of the fibrous substrate and the film, the adhesive composition bonding the film to the fibrous substrate.

2. A composite article as defined in claim 1, wherein the fibrous substrate has a three dimensional shape and wherein the film has been subjected to sufficient heat and pressure in order to assume the shape of the fibrous substrate.

3. A composite article as defined in claim 1, wherein the film has a thickness of from about 10 microns to about 1000 microns.

4. A composite article as defined in claim 1, wherein the fibrous substrate is in the shape of a container having an interior surface and an exterior surface, the film covering at least the interior surface.

5. A composite article as defined in claim 4, wherein the composite article comprises a food container.

6. A composite article as defined in claim 1, wherein the film comprises an extruded film.

7. A composite article as defined in claim 1, wherein the adhesive composition is present and comprises an acrylic-based polymer.

8. A composite article as defined in claim 1, wherein the cellulose ester polymer comprises a cellulose acetate, the cellulose acetate comprising primarily cellulose diacetate.

9. A composite article as defined in claim 1, wherein the film contains the cellulose ester polymer in an amount from about 55% to about 95% by weight and contains the plasticizer in an amount from about 5% by weight to about 45% by weight.

10. A composite article as defined in claim 1, wherein the cellulose ester polymer comprises a cellulose acetate having a degree of substitution of from about 2.1 to about 2.8.

11. A composite article as defined in claim 1, wherein the fibrous substrate comprises plant fibers, such as pulp fibers, bamboo fibers, corn husk fibers, or mixtures thereof.

12. A composite article as defined in claim 1, wherein the fibrous substrate comprises pulp fibers.

13. A composite article as defined in claim 1, wherein the fibrous substrate comprises the biodegradable and/or paper recyclable fibers in an amount of at least about 60% by weight.

14. A composite article as defined in claim 1, wherein the plasticizer comprises a triglyceride, polyethylene glycol, or mixtures thereof.

15. A composite article as defined in claim 1, wherein the surface of the fibrous substrate and the film have an average bond strength of greater than about 0.75 N when measured according to a 90 degree peel test at a speed of 12 inches per minute.

16. A composite article as defined in claim 1, wherein the adhesive composition is present and comprises a biodegradable and/or water soluble, paper recyclable polymer.

17. A composite article as defined in claim 1, wherein printed matter or laser markings are present between the surface of the fibrous substrate and the film.

18. A method of making composite articles comprising:
laminating a film to a surface of a fibrous substrate, the film comprising a biodegradable and/or paper recyclable polymer, the film defining a film surface, optionally an adhesive composition having been applied to the film surface, the biodegradable and/or paper recyclable polymer comprising a cellulose ester polymer, the film further comprising a plasticizer, the fibrous substrate comprising a network of biodegradable and/or paper recyclable fibers, the fibrous substrate defining a fibrous surface, the film surface being laminated to the fibrous surface by applying pressure causing the film to bond the fibrous surface.

19. A method as defined in claim 18, wherein the film is coated with the adhesive composition and is unwound from a roll of material and laminated to the fibrous surface.

20. A method as defined in claim 18, wherein the fibrous substrate is placed in a mold while the film is positioned over the fibrous surface and wherein the method includes applying a suction force through the fibrous substrate for causing the film to conform to a shape of the fibrous surface and bond to the fibrous surface.

21. A method as defined in claim 18, wherein the fibrous substrate is placed in a mold while the film is positioned over the fibrous surface and wherein the method includes applying a suction force through the fibrous substrate while simultaneously pushing the film with a plug that matches the shape of the fibrous surface causing the film to conform to a shape of the fibrous surface and bond to the fibrous surface.

22. A method as defined in claim 18, wherein the fibrous substrate is placed in a mold while the film is positioned over the fibrous substrate and wherein the method includes applying a pneumatic force to the film for forcing the film against a surface of the fibrous substrate and causing the film to conform to a shape of the fibrous surface and bond to the fibrous surface.
